(19) United States
(12) Patent Application Publication
(10) Pub. No.: US 2011/0130956 A1
(43) Pub. Date: Jun. 2, 2011

(54) METHOD AND APPARATUS FOR PRESENTING CONTEXTUALLY APPROPRIATE NAVIGATION INSTRUCTIONS

(75) Inventors: Kenneth Tracton, Palo Alto, CA (US); Quinn Jacobson, Sunnyvale, CA (US); Cynthia Kuo, Mountain View, CA (US); Andriy Shnyr, Berlin (DE); Ciprian Cudalbu, Berlin (DE)

(73) Assignee: Nokia Corporation, Espoo (FI)

(21) Appl. No.: 12/627,278

(22) Filed: Nov. 30, 2009

(51) Int. Cl. G01C 21/36; G06F 3/048

(52) U.S. Cl. 701/201; 715/764

(57) ABSTRACT

An approach is provided for providing guidance information to a user. A request is received, from a device, for guidance information to a destination, wherein the guidance information includes, at least in part, instructions for following a route to the destination. A plurality of candidate reference points associated with the route are determined. One or more of the plurality of candidate reference points are selected to include in the instructions based on saliency of the one or more candidate reference points with respect to one or more comprehension parameters associated with a user. The instructions are generated based on the one or more selected reference points. The comprehension parameters relate to the ability of the user to recognize the selected one or more reference points.

### BACKGROUND

Service providers and device manufacturers are continually challenged to deliver value and convenience to consumers by, for example, providing compelling network services, such as navigational services. Traditionally, these navigational services provide navigational directions and routing information using street names and actual distances (e.g., miles to a next turn). Such approaches, however, may result in the user not following the specified route, in large part, because the user may not have any knowledge of or familiarity with the particular street names in a given area or because the user is unable to follow the directions. That is, these traditional routing services may be confusing if the user finds it difficult or lacks the ability to follow the directions provided.

### SOME EXAMPLE EMBODIMENTS

Therefore, an approach is provided for presenting contextually appropriate navigation instructions.

According to one embodiment, a method comprises receiving a request, from a device, for guidance information to a destination. The guidance information includes, at least in part, instructions for following a route to the destination. The method also comprises determining a plurality of candidate reference points associated with the route. The method further comprises selecting one or more of the plurality of candidate reference points to include in the instructions based on saliency of the one or more candidate reference points with respect to one or more comprehension parameters associated with a user; and generating the instructions based on the one or more selected reference points. The comprehension parameters relate to the ability of the user to recognize the selected one or more reference points.

According to another embodiment, an apparatus comprising at least one processor, and at least one memory including computer program code, the at least one memory and the computer program code configured to, with the at least one processor, cause, at least in part, the apparatus to receive a request, from a device, for guidance information to a destination. The guidance information includes, at least in part, instructions for following a route to the destination. The apparatus is also caused to determine a plurality of candidate reference points associated with the route. The apparatus is further caused to select one or more of the plurality of candidate reference points to include in the instructions based on saliency of the one or more candidate reference points with respect to one or more comprehension parameters associated with a user. The apparatus is additionally caused to generate the instructions based on the one or more selected reference points. The comprehension parameters relate to the ability of the user to recognize the selected one or more reference points.

According to another embodiment, a computer-readable storage medium carrying one or more sequences of one or more instructions which, when executed by one or more processors, cause, at least in part, an apparatus to receive a request, from a device, for guidance information to a destination. The guidance information includes, at least in part, instructions for following a route to the destination. The apparatus is also caused to determine a plurality of candidate reference points associated with the route. The apparatus is further caused to select one or more of the plurality of candidate reference points to include in the instructions based on saliency of the one or more candidate reference points with respect to one or more comprehension parameters associated with a user. The apparatus is additionally caused to generate the instructions based on the one or more selected reference points. The comprehension parameters relate to the ability of the user to recognize the selected one or more reference points.

According to another embodiment, an apparatus comprises means for receiving a request, from a device, for guidance information to a destination. The guidance information includes, at least in part, instructions for following a route to the destination. The apparatus also comprises means for determining a plurality of candidate reference points associated with the route. The apparatus further comprises means for selecting one or more of the plurality of candidate reference points to include in the instructions based on saliency of the one or more candidate reference points with respect to one or more comprehension parameters associated with a user. The apparatus further comprises means for generating the instructions based on the one or more selected reference points. The comprehension parameters relate to the ability of the user to recognize the selected one or more reference points.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing guidance information to a user of user equipment, according to one embodiment;

FIGS. 2A and 2B are map diagrams capable of describing the structure of guidance instructions provided by the system, according to various embodiments;

FIGS. 2C and 2D are map diagrams presenting exemplary multilingual maps, according to various embodiments;

FIG. 2E is a flowchart of a process for providing navigational guidance based on multilingual maps, according to one embodiment;

FIG. 3 is a diagram of the components of navigation assistance module, according to one embodiment;

FIGS. 4 and 5 are flowcharts of processes for providing navigation guidance instructions, according to various embodiment;

FIG. 6 is a diagram of a user interface utilized in the processes of FIGS. 4 and 5, according to one embodiment;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program for providing guidance information based on user-related contextual information are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

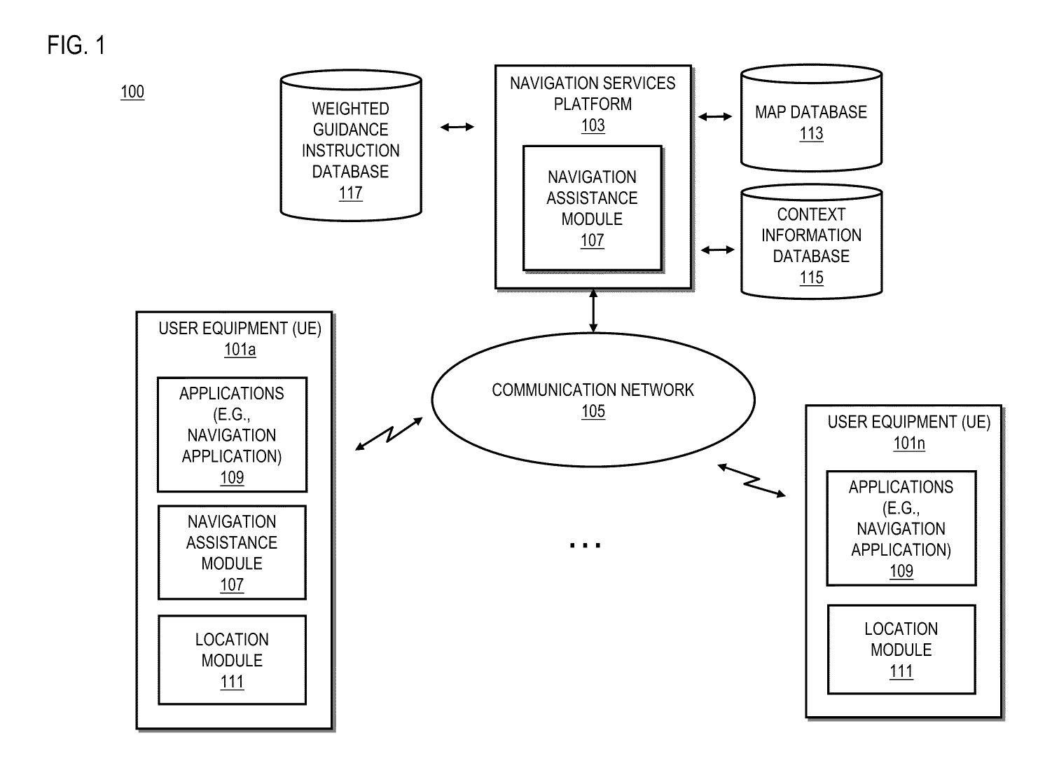

FIG. 1 is a diagram of a system capable of providing contextually appropriate guidance information (e.g., based on the capability of a user to comprehend the guidance information), according to one embodiment. As mentioned, navigational services have traditionally relied on map interfaces and street names to convey routing and map-related information to users. By way of example, users are generally provided with navigational maps and/or routing information in terms of street names and distances. These instructions include, for instance, “Turn left onto El Camino Real/CA-82 N in 1.7 miles” or “Proceed straight onto University Avenue for 5.2 miles.” However, these instructions are provided under the assumption that all users have the same general ability to understand and follow these instructions. For example, the instruction to “Turn left onto El Camino Real/CA-82 N in 1.8 miles” assumes that the user is able to verify that the user is turning left at the correct street by locating and reading a street sign. In some situations, this assumption is inappropriate. Environmental conditions (e.g., weather, availability of light, temporary obstructions, etc.) may make it difficult or impossible to see or read the street sign. Moreover, personal characteristics of the user (e.g., physical impairment, literacy, physical condition, preferences, mode of transportation, etc.) can also affect the ability of a user to follow and/or comprehend a set of guidance instructions.

These conditions and/or characteristics may also make it more difficult to understand or comprehend specific media (e.g., visual or aural media) used to convey the guidance instructions. For example, in a noisy environment, the user may not be able to hear navigation instruction. Conversely, if the user is driving in busy traffic, the user may not be able to safely read the instructions from a navigation screen for instructions. Traditionally, navigation services do not take or automatically take these conditions and/or characteristics into account with delivery navigation instruction to users.

To address this problem, a system 100 of FIG. 1 introduces the capability to provide guidance information that is customized for each user based on the capability of the user to comprehend the guidance information. In certain embodiments, guidance information is data that is generated to provide guidance instructions to the user as to how to reach a selected destination from a particular starting point. Guidance instructions may be directions that are provided to the user at guidance or reference points (e.g., where a user has the option to maneuver and/or is told to turn or provided with other instructions) during the navigation of a route to the destination. In one embodiment, the guidance or reference points may be prominent landmarks, features, or other elements of terrain that are recognizable or salient to the user. Specific reference points that are included in guidance information or instructions are determined, for instance, by evaluating a group of candidate or potential reference points for their salience with respect to one or more comprehension parameters of a user. For example, the system 100 may select a group of reference points that are within proximity of a navigation route. The system 100 then determines which of those references points are most prominent to a user given user preferences (e.g., physical characteristics, literacy, preferred language, etc.). These guidance or reference points may be located at any point along a path to the destination that the user has an ability to maneuver (e.g., turn, take an exit, etc.). Moreover, in certain embodiments, if there are multiple potential routes, the system 100 may select a set of reference points for each of the candidate routes and selects the most appropriate route based on the salience or applicability to a specific user. For example, if the user is traveling by bicycle, the system 100 may weight more highly and/or favor those routes with fewer hills.

In the approach described herein, guidance instructions may be processed to be contextually appropriate for the user. In this manner, customized directions may be provided for each user. In other words, two users with different capabilities may receive different guidance instructions to the same destination from the same starting location based on individual capabilities. Further, the guidance instructions may be based on other contextual information such as the safety of navigating a particular path to the destination. Moreover, the guidance instructions may be provided in an aural format to the user in a language that the user may comprehend. In certain embodiments, the guidance instructions are based on cues determined from reference points, such as landmarks, points of interest (POIs), street intersections, road detail descriptions, buildings, train tracks, signs, traffic lights, parks, changes in elevation (e.g., hills, overpass, underpass, etc.), boundaries in environmental changes (e.g., the boundary between a residential area and commercial area), etc. associated with map data. A reference point may be any object that may be utilized as a basis for providing guidance instructions. Exemplary reference points may include a count of a certain type of landmark or point of interest (e.g., after four stop signs, turn right), a change in the environment (e.g., continue down the residential street for two blocks until the user sees a restaurant district), instructions based on the saliency of a point of interest or a landmark (e.g., turn right at the triangular red building), a combination thereof, etc.

As shown in the system 100 of FIG. 1, one or more user equipment (UEs) 101a-101n may receive guidance instructions from a navigation services platform 103 via a communication network 105 or may determine the guidance instructions at the UE 101 using a navigation assistance module 107. In one embodiment, a UE 101a may include the navigation assistance module 107 while another UE 101n may utilize the navigation assistance module 107 of the navigation services platform 103. The UE 101 may utilize a navigation application 109 to retrieve and present the guidance instructions. In certain embodiments, the navigation application 109 may utilize audio capabilities of the UE 101 to present the guidance instructions. A location module 111 associated with the UE 101 may be utilized to provide the current location of the UE 101 to the navigation assistance module 107 for route guidance. The location of the UE 101 may be utilized as a starting point to route a path to a destination. The user may specify information about the destination via the navigation application 109.

Once the starting point and destination are determined, the navigation assistance module 107 may utilize a map database 113, a context information database 115, and a weighted guidance instruction database 117 to determine path routing and guidance instructions to the destination. The navigation assistance module 107 may have direct access to the databases 113, 115, 117 (e.g., the databases are stored on a memory associated with the platform the navigation assistance module 107 is located) or may have access to the databases 113, 115, 117 via the communication network 105. The navigation assistance module 107 may utilize the databases 113, 115, 117 to determine a contextually appropriate route for the user to travel to the destination from the start point.

In certain embodiments, the map database 113 is utilized by the navigation assistance module 107 to determine contextually appropriate guidance information. The map database 113 includes data to assist in determining the contextually appropriate guidance information such as: (1) image data stored based on the geo-location of the image; (2) topographical maps; (3) a POI database associating POIs with geo-location information; (4) processed street data that may include information about streets, cross streets, and signs associated with the streets as well as road closures, sidewalk data, and other path data (e.g., bike paths or hiking paths); (5) map images stored as map tiles with associated metadata including textual information associated with street, city, region, and/or point of interest names; or a combination thereof. Much of this data may be used to determine reference points (e.g., landmarks, map features, etc.) that may be utilized to provide guidance instructions. As such, the processed image data may be used to determine the number of buildings between streets, the colors of buildings and POIs, other distinguishing features regarding POIs that may be utilized to determine a saliency of the reference point. The data stored in the map database 113 may be used to describe properties (e.g., physical characteristics of a reference point, safety information associated with the reference point, access restrictions associated with the reference point, etc.) of one or more reference points referenced in guidance instructions available to a user. By way of example, these properties or characteristics may specify features associated with the reference point that can be used to distinguish the reference point while providing directions. For example, in the guidance instruction “turn left at the red building,” the property of the building reference point that the building is red is used to distinguish the building from other building reference points in the area. The properties may be associated with the weighting of guidance instructions and the reference points for determining which guidance instructions to present to a user.

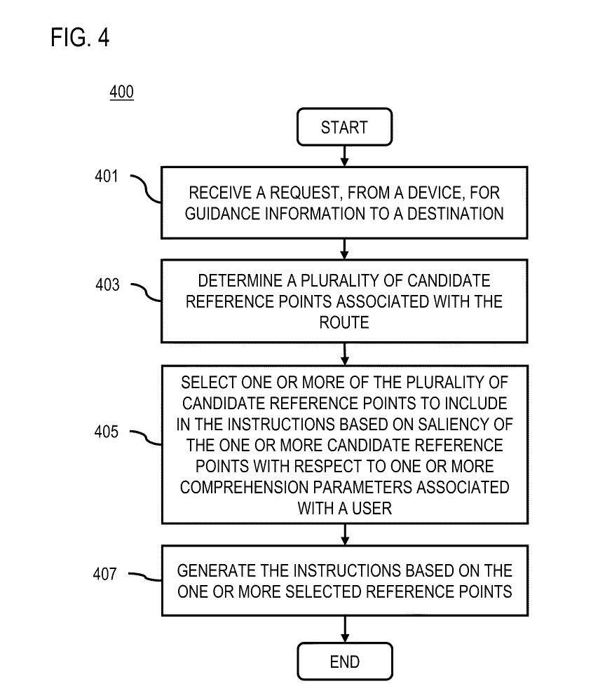

In some embodiments, properties may include associations with the reference point that make it more or less likely that a reference point is correct to present to the user based on a rule. In one embodiment, one rule may associate the reference point with a weighting based on how prominent or recognizable the reference point is to a user. This rule may utilize parameters (e.g., comprehension parameters) as further described in the processes of FIG. 4 to determine an amount of weight to associate with a reference point. In certain embodiments, comprehension parameters are related to the ability of the user to recognize guidance instructions based on characteristics of a reference point associated with the guidance instructions. In one example, an associated property of the reference point is that the reference point is red. In this example, if the comprehension parameters indicate that the user is color blind, the reference point may be negatively weighted because the user is unable to recognize that the reference point is red. If this is a prominent feature of the reference point that may be utilized to describe the reference point in the guidance instructions, then weighting may be more negative. In another example, a dark colored building may be prominent to a user in the daytime, but may be much less prominent at night. Accordingly, the system 100 may weight the dark colored building more positively during daytime hours and more negatively at night. In another example, an associated property or characteristic of the reference point can include that the reference point is in an unsafe area. In this example, if a user prefers specifies a parameter to only be routed through safe areas, reference point may be avoided in the route (e.g., by receiving a negative rating). In other words, some embodiments of the system 100 may use safety data as a factor in combination with the comprehension parameters for selecting a particular route. In yet another embodiment, the system 100 may use “comfort data” (e.g., data corresponding to how easily or comfortably a particular route can be traversed) as another factor in selecting a route. By way of example, comfort data may include topographical information describing elevation changes. Per the bicycling example above, a casual bicycler may chose routes that are flatter to ensure that a particular trip is more “comfortable” or easier to travel.

Moreover, in some embodiments, the context information database 115 is used by the navigation assistance module 107 to associate guidance instructions associated with reference points to a user context and includes a user profile, a trip profile, environmental data, safety data, a combination thereof, etc. This contextual information may be used along with the map information to determine guidance instructions for the user. The user profile may be specific to a particular user and may include a location history of places the UE 101 has been, a language parameter to synchronize the guidance instructions with the user both in aural and a visual manner, user characteristics (e.g., colorblindness, handicaps, impairments, etc.), user preferences (e.g., based on a mode of travel, avoidance of certain types of routes, safety preferences, etc.), a combination thereof, or the like. Additionally, environmental data may be utilized to provide certain contextual properties to landmarks that may be used to provide guidance instructions based on conditions associated with areas that may be used in determining the route, such as current traffic data, current weather data (e.g., cloudy, sunny, raining, foggy, low visibility, etc.), current events occurring in certain regions, construction on roadways, etc. Similarly, safety data that relates to the safety of a user navigating through various areas associated with the route can be collected and stored in the context information database 115 and may include crime data, lighting data (e.g., number and locations of street lamps), accident data, and/or other like information. In certain embodiments, regions with poor safety parameters may be filtered out from available routes to path to the destination.

Further, the trip profile may include information about the current trip from a start point (e.g., current UE position) to a destination as well as the mode of travel (e.g., walking, bicycling, driving, etc.), time of day, and date. In one embodiment, reference points may be associated with dynamic properties that change based on an attribute or condition such as the time of day. For example, a reference point may include a safety property that is dynamic (e.g., the reference point may have one level of safety at night time and another safety value at day time). In this way, dynamic properties enable the navigation assistance module to customize guidance information with greater granularity. Dynamic properties may also be influenced by other contextual information such as weather, mode of travel, user language, and the like. Further, the time of day may be used to determine the available sunlight or available artificial lighting and influence other dynamic properties (e.g., a road may change directions or increase lanes at certain times of day) of guidance instructions based on the time. Further, the date may be utilized to determine if the day is a weekday, weekend, holiday, etc. a particular day of the week because each type of day may also affect what value or characteristic is assigned to a dynamic property (e.g., road closures on Friday, weekend traffic patterns in cities, etc.).

Moreover, the location module 111 may be utilized to modify and update the trip profile. The start point in the trip profile may be determined to be the user's current location. The user's location can be determined by a triangulation system such as a global positioning system (GPS), assisted GPS (A-GPS) A-GPS, Cell of Origin, wireless local area network triangulation, or other location extrapolation technologies. Standard GPS and A-GPS systems can use satellites to pinpoint the location of a UE 101. A Cell of Origin system can be used to determine the cellular tower that a cellular UE 101 is synchronized with. This information provides a coarse location of the UE 101 because the cellular tower can have a unique cellular identifier (cell-ID) that can be geographically mapped. The location module 111 may also utilize multiple technologies to detect the location of the UE 101. GPS coordinates can provide finer detail as to the location of the UE 101. Some or all of the content in the trip profile, user profile, and/or other contextual information may be updated by the user via the UE 101 during use of the system 100.

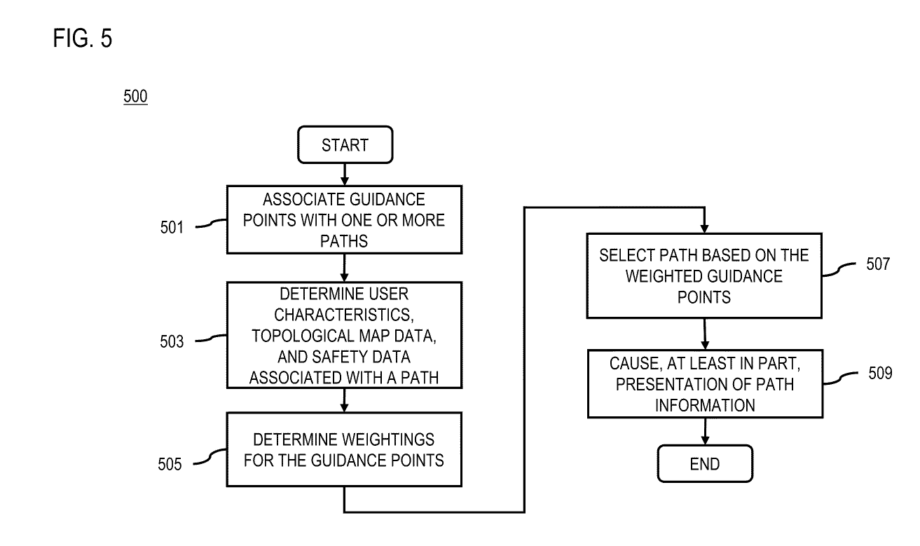

Moreover, in some embodiments, the weighted guidance instruction database 117 includes attributes for signifying usefulness or appropriateness of instructional information with respect to a particular context. In one embodiment, the appropriateness of instructional information is determined by associating parameters in the user profile (e.g., preferences, user characteristics, etc.) with properties (e.g., salience, safety, access restrictions, etc.) associated with reference points. In one example, it would not be appropriate to provide instructions associated with a “red building” reference point if the user indicates in the profile that the user is colorblind. Some or all of the reference points (e.g., routing segments, POIs, landmarks, streets, foot paths, etc.) may be utilized to provide one or more guidance instructions (e.g., a big red building landmark may be associated with a “turn left at big red building” instruction). Further, collections of reference points may be associated with guidance instructions (e.g., “pass five buildings on your right”). Each of the reference points and guidance instructions may be associated with attributes that may be used to determine the appropriateness of the guidance instruction in a contextual situation. Thus, each of the reference points for providing guidance instructions may include a base weighting that may be adjusted based on the information contained in the map database 113 and the context information database 115. Further, the user profile or trip profile may be used to determine parameters to readjust the weighting structure (e.g., the user profile may be used to weight the guidance instructions towards safer routes or routes that do not induce motion sickness). The navigation assistance module 107 may be utilized to combine the information from the weighted guidance instruction database 117 with information from with the map database 113 and the context information database 115 to determine contextually appropriate routes and navigation instructions as further detailed in FIG. 5. Moreover, portions or all of the weighted guidance instruction database 117, the context information database 115, and the map database 113 may be combined into a single database. The weighted guidance instruction database 117 may store data in a format that is associated with reference points. The properties of the reference points may include information as to how contextual information changes the weighting of each of the reference points.

In one example, the reference point is a big red building and associated guidance instructions instruct the user to move in a direction in relation to the big red building. By way of example, in a system that weights the reference points on a 1 to 10 scale based on their saliency or distinguishing characteristics, the reference point may be initially weighted at 7 out of 10 because of the distinguishing characteristics that the building is big and red. The reference point may not receive a 10 out of 10 because there are other big buildings in the area, but may receive a 7 because it is the only big red building in the area. Then, user profile data may be taken into place to adjust the weighting. For example, if the user profile indicates that the user is color blind and cannot distinguish the color red, the usefulness of instructions using this reference point are greatly lowered, In such a case, the reference point for guidance instructions may be adjusted by a weight of −7 or by a multiple of 0 to indicate that the reference point is not useful to this particular user. In certain embodiments, the scale may be from integer values from 1-10; in other embodiments, the scale can include negative numbers, floating point numbers, etc.

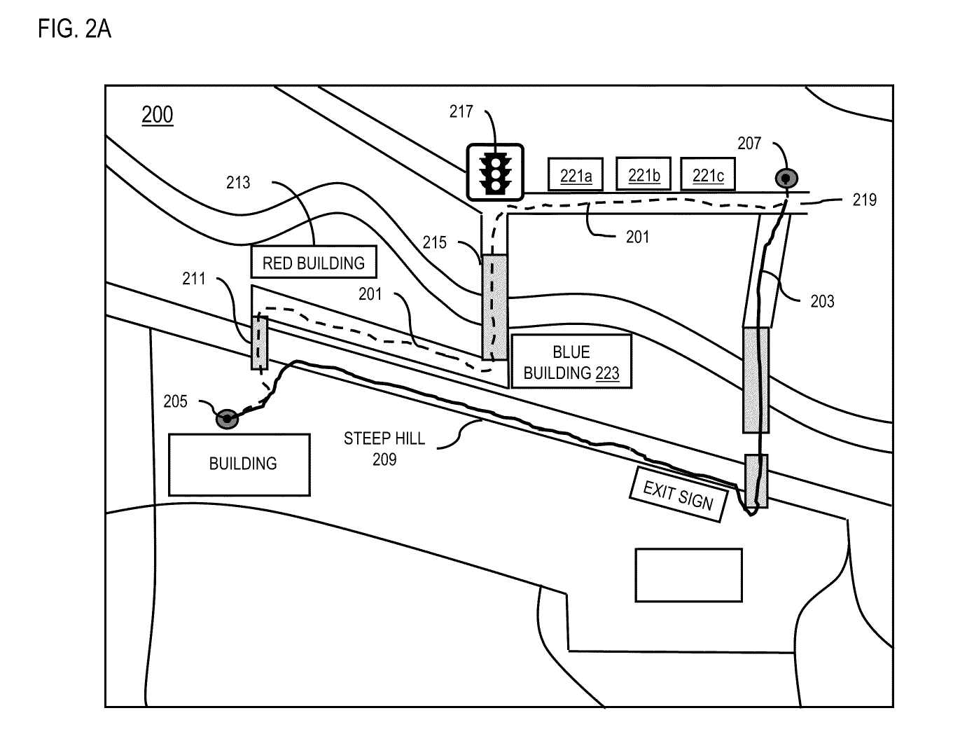

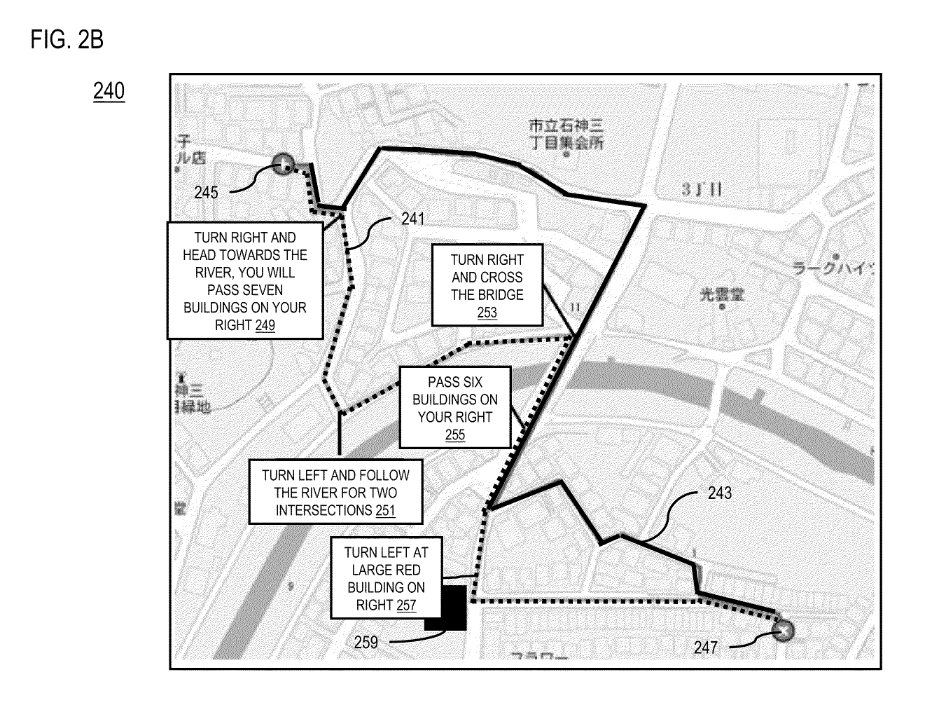

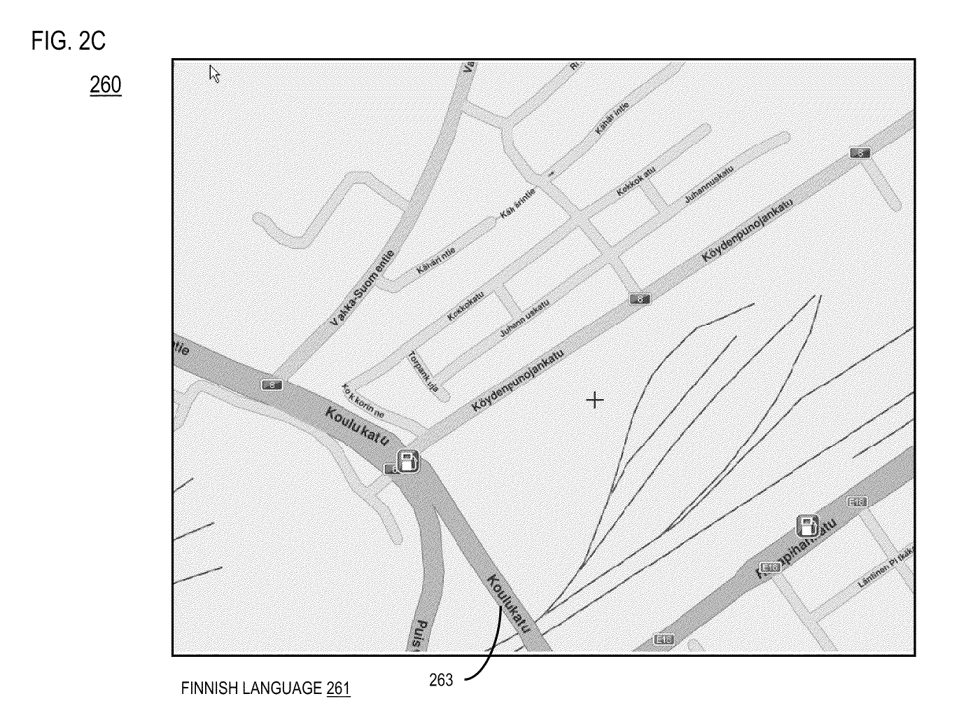

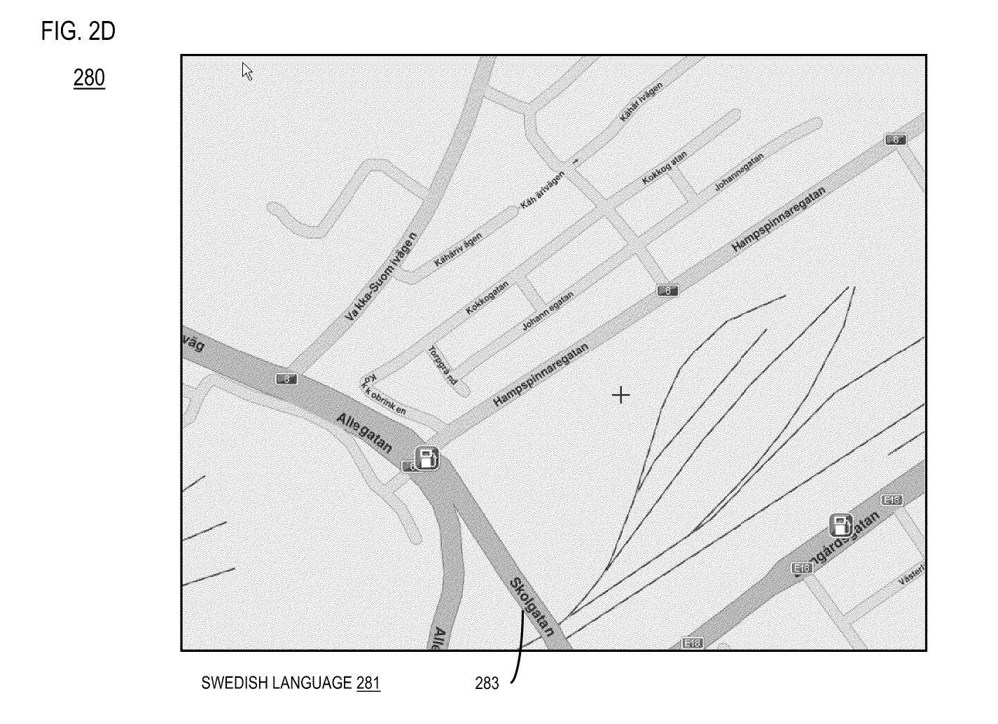

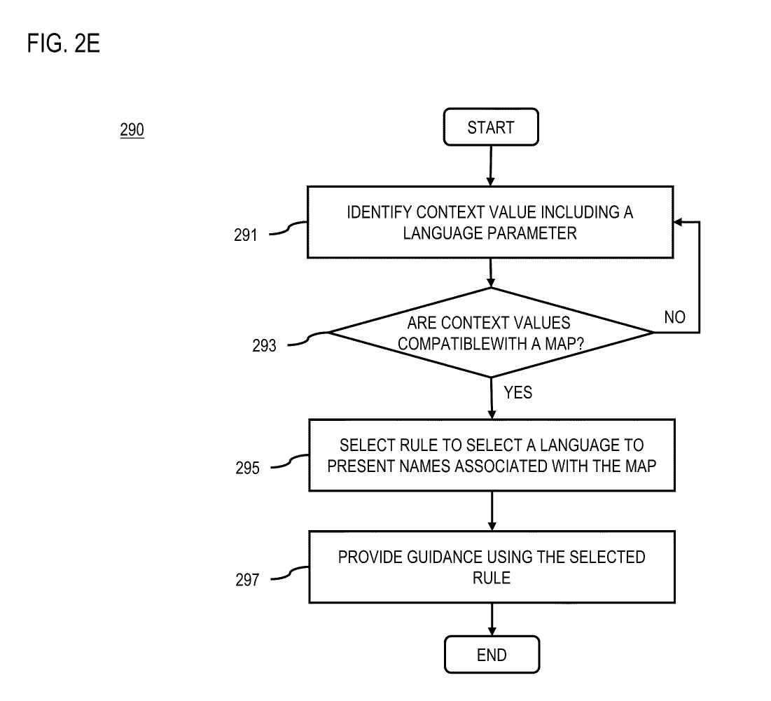

In another example, the reference point is a street sign. The reference point may be initially weighted as a 5 out of 10 because it is not particularly distinguishing, but it does include a name of the street. The user profile may indicate that the user is functionally illiterate and cannot read street signs; in this case, the weight may be determined to be adjusted by −5 to indicate that the reference point is not useful. Moreover, the user may indicate in the user profile that the user wishes to operate the UE 101 and/or navigation application 109 in a particular language. In this scenario, the navigation application 109 may store the preference in a language parameter and present mapping information and guidance instructions in the particular language. This mapping information may include reference point identifiers (e.g., names of the streets, cities, states, regions, POIs, etc.) as further detailed in FIGS. 2C and 2D. For example, the system 100 may determine the preferred language from the language parameter and then select the an identifier from a lookup table containing the identifier expressed in multiple languages.

In yet another example, the user's profile may indicate a preference to use a safe route while traveling. The navigation assistance module 107 may retrieve safety data about the area associated with the street sign from a context information database 115. The reference point may be considered to be in a very safe area, thus, the reference point may be weighted accordingly (e.g., add +2 to the weight). Moreover the contextual information may indicate that the current time is after sunset and data may include that the sign is well lit at night. Under this scenario, a neutral weight (e.g., add 0 to the base) may be set for the reference point based on lighting. If the reference point is less able to be seen, the neutral weight may be adjusted to be a negative weight (e.g., subtract 1 from the base). In other scenarios, if the sign is independently lighted (e.g., a neon sign), the reference point may be more visible after dark and thus be adjusted positively at night.

In another example, the user's profile may indicate a preference for comfortable routes. Comfort may be defined both physically and psychologically. For example, routes that traverse mountainous, windy roads are more likely to induce motion sickness. If the user specifies a preference for routes that are less likely to induce motion sickness, windy roads may be adjusted by a negative weight. Similarly, routes with uneven surfaces, debris, construction, or cobblestone streets may be negatively weighted for the comfort of bicyclists. Psychological comfort may include fears, superstitions, or prejudices. For example, a recovering alcoholic may be more comfortable avoiding an area with liquor stores for fear of relapse, while a teetotaler may avoid the liquor stores due to personal prejudice. As such, the user may specify in the user profile that the user is a recovering alcoholic and the navigation assistance module 107 can link the recovering alcoholic parameter to a determination that the user wishes to avoid areas with liquor stores or bars.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), satellite, mobile ad-hoc network (MANET), and the like.

The UE 101 is any type of mobile terminal, fixed terminal, or portable terminal including a mobile handset, station, unit, device, navigational device, multimedia computer, multimedia tablet, Internet node, communicator, desktop computer, laptop computer, Personal Digital Assistants (PDAs), or any combination thereof. It is also contemplated that the UE 101 can support any type of interface to the user (such as “wearable” circuitry, etc.).

By way of example, the UE 101 and navigation services platform 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the navigation application 109 and navigation assistance module 107 interact according to a client-server model. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

FIGS. 2A and 2B are map diagrams capable of describing the structure of guidance instruction provided by the system, according to various embodiments. Map diagram 200 displays a dotted path 201 representing a route recommended for a pedestrian user and a solid path 203 representing a route recommended for an automobile user. Both paths represent routes from a starting point 205 to a destination 207. The starting point 205 may be determined by a location module 111 of a UE 101 providing a navigation application 109 to the user and the destination 207 may be selected by the user. Each of the routes may be determined by the navigation assistance module 107 as further described in FIGS. 4 and 5. In this map diagram, selected guidance instructions are selected to exemplify the use of the weighted guidance instruction database 117, map database 113, and context information database 115 to determine navigational routes and guidance instructions for presentation and are not exhaustive.

The routes may be determined based on user profiles associated with each path. First, the user profile and/or trip profile for the automobile user may be optimized to utilize standard routing using standard street information. Portions of the dotted route may be unavailable to the automobile user because the portions may be blocked to automobiles. For example, a pedestrian foot overpass 211 may be inaccessible to the routing of the automobile path. The navigation assistance module 107 may determine the automobile path 203 by dynamically incorporating the user and trip profiles with the weighted guidance instruction database 117 as further detailed in the processes of FIGS. 4 and 5.

Further, the dotted path 201 may be for a pedestrian user. In certain embodiments, the user preferences for pedestrian routing include an attribute associated with a hill grade. Hill grade information may be stored in a topographical map of the area. If a portion of the route is associated with a steep hill 209, the portion may be provided a lower weight (e.g., by subtracting from the base weighting). Routes with the highest weightings may be selected for presentation to the user. As such, the user is prompted to navigate along the dotted path 201 instead of towards the automobile path. The user may be provided instructions to walk towards the pedestrian overpass 211, walk over the pedestrian overpass 211, and turn right on a particular street at a red building 213. Then the user may be provided instructions to walk along the street until reaching a bridge 215. Once the user is close to the bridge 215, the user may be provided additional instructions to turn left at the bridge 215 and walk over the bridge 215. Next, the navigation assistance module 107 may determine that the user should turn right at the next traffic light 217 onto another street 219. Moreover, the user may be provided instructions to walk along street 219, pass three buildings 221a, 221b, 221c on the left hand side, and the destination is on the left hand side. Each of the reference points 211, 213, 215, 217, 219, 221 used to provide instructions may be weighted and presented according to the processes of FIGS. 4 and 5. Other landmarks or reference points, such as blue building 223 may not be presented because more appropriate (e.g., higher weighted) guidance instructions were used (e.g., the bridge 215). As such, the salience of the landmarks or reference points may be utilized to determine weight the use of guidance instructions. In this case, a bridge 215 may be considered more distinctive than a blue building 223 and thus may receive a greater weighting and is thus selected.

According to another embodiment, FIG. 2B displays map 240 with a dotted route 241 representing a route for a user indicating that the user is functionally illiterate in a particular area and a solid route 243 representing a route for a user indicating that the user is literate and can read street or building signs in the particular area. The functionally illiterate user may be a tourist new to the country that is unable to comprehend languages used (e.g., on navigation exit signs) to in the particular area. Both routes may be automobile navigation routes and may be routed from a starting point 245 to a destination 247. The solid route 243 may be routed and guided using conventional means while the dotted route 241 is routed based on the user's ability to comprehend directions. Under this scenario, the user is functionally illiterate, that is, the user cannot read or write the language (e.g., Japanese) that street signs in the area are written in. Under this scenario, the user may visit an area (e.g., another country or another region) that includes street signs and other signs in a language the user does not understand. In other words, the user may be functionally illiterate in one language even though the user may be literate in another language (e.g., English). Under certain scenarios, the instructions may be provided in a language selected by the user even though the area the user is in utilizes another language.

The navigation assistance module 107 may determine the path based on guidance instructions that can be offered using the path. In certain scenarios, paths with more salient features may be utilized to offer guidance optimized instructions. In this scenario, the navigation assistance module 107 may determine multiple paths from the starting point 245 to the destination 247 using various algorithms. Each potential or candidate path may be segmented into portions based on guidance points (e.g., where the user may be required to turn, where the user may select an exit, where the user may be updated on the area, etc.). Each segment at a guidance point may include a Euclidean heading and distance to the next guidance point in the path. At each of these guidance points, one or more guidance instructions associated with reference points may be selected based on each reference point's weighting compared to the other reference points available in the area. Further, some instructions may include descriptions of navigating to the next guidance point after passing the current guidance point (e.g., “turn left at the Landmark” and then “walk about 70 steps to the pier”). The path with the greatest weighting may be selected to present to the user. In certain scenarios, the path with the greatest weighting is normalized based on the amount of guidance points associated with the path.

In the particular case of the dotted route 241, the user is provided instructions to “turn right and head towards the river, you will pass seven buildings on your right” at a first guidance point 249. Then, after the user passes seven buildings on the user's right hand side, the user reaches a second guidance point 251, where the user is instructed to “turn left and follow the river for two intersections.” The user may follow the path until the user reaches a third guidance point 253, where the user is provided instructions to “turn right and cross the bridge.” After the user crosses the bridge, the user may be at a forth guidance point 255, where the user is provided instructions to “pass six buildings on your right.” As the user continues on the dotted route 241 and reaches a fifth guidance point 257, the user is instructed to “turn left at the large red building 259 on the right.” After the user turns, the user may be provided an indication as to where the destination is (e.g., follow the street for fifteen buildings and the destination will be on the right).

FIGS. 2C and 2D are map diagrams presenting exemplary multilingual maps, according to various embodiments. As shown, map 260 and map 280 display a map area in the Finnish language 261 and Swedish language 281. In certain embodiments, maps are generated from map tiles and each map tile may correspond to a zoom level. Each tile may have associated with it metadata information associated with the respective tile. This metadata information may include the names of streets, POIs, reference points, cities, states, regions, etc. Moreover, the names can be stored with translations in two or more languages. The language to present to the user may be determined based on the user profile and/or may be selected by the user. In certain scenarios, the language may be set to a dynamic setting based on a language associated with a set of GPS coordinates. For example, this may be implemented by associating GPS coordinates with a country or region (e.g., a portion of a country that utilizes a different language or dialect) that has a default associated language. The languages may include common alphabets (e.g., English, Swedish, Finnish, French, etc.) as well as other characters (e.g., Chinese, Japanese, etc.) and types of languages (e.g., Cyrillic, Arabic).

To display the language information on a map 260, 280, the UE 101 can utilize a table associating languages with metadata names, display sizes, position on a map or map tile, zoom levels, etc. Table 1 presents exemplary associations.

TABLE 1

| | | | Zoom | | | | |
|---|---|---|---|---|---|---|---|
| 1 | Size | Pos. | level | Russian | Swedish | Finnish | English |
| 2 | 10 | | 1, 2, 3 | [symbol] | Moskva | Moskova | Moscow |
| 3 | . . . | | 1, 2, 3 | . . . | Stockholm | Tukholma | Stockholm |
| 4 | . . . | | 1, 2 | . . . | Helsingfors | Helsinki | Helsinki |
| 5 | . . . | . . . | 13, 14 | . . . | Skolgatan | Koulukatu | . . . |
| 6 | . . . | . . . | 13, 14 | . . . | Hamspinnaregatan | Käydenpunojankatu | . . . |
| 7 | . . . | . . . | 14 | . . . | Vakka-Suomivägen | Vakka-Suomentie | . . . |
| 8 | . . . | . . . | 14 | . . . | [symbol] | Ratapihankatu | . . . |
| 9 | | . . . | 14 | . . . | Johannegatan | Juhannuskatu | . . . |
| . . . | | . . . | | . . . | . . . | . . . | . . . |
| . . . | | . . . | | . . . | . . . | . . . | . . . |

As shown in Table 1, the Finnish name Koulukatu 283 can be displayed in Swedish as Skolgatan. Moreover, the zoom level association with the names is 13 and 14, which can identify that the names are only to be displayed at these zoom levels. For example, street names, like the items in row 5 may be displayed on a micro level while city names, like items in row 2, 3, and 4 may be displayed at a more macro level (e.g., zoom levels 1, 2, and 3). Moreover, the table can provide for the font size of the display as well as the position of the display. The position may include a starting coordinate or pixel and a vector as to which direction to display the name. Similarly, POIs and other reference points may be described in multiple languages and associated via metadata. The table utilized may be created by conventional data entry means or by utilizing a translation engine. The table may be stored on a memory of the UE 101 or may be stored in the map database 113 and associated as metadata when a map tile is transmitted from the navigation services platform 103 to the UE 101.

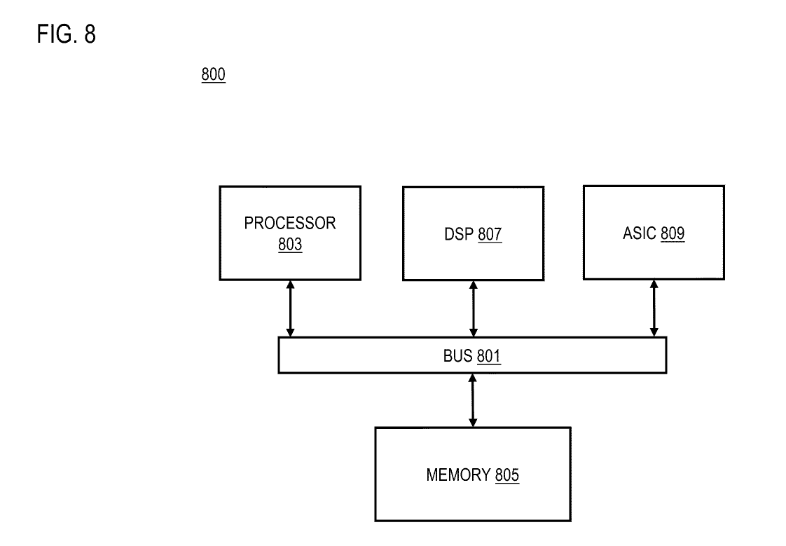

FIG. 2E is a flowchart of a process for providing navigational guidance based on multilingual maps, according to one embodiment. In one embodiment, the navigation application 109 performs the process 290 and is implemented in, for instance, a chip set including a processor and a memory as shown FIG. 8. In step 291, the navigation application 109 identifies a context value that includes a language setting on the UE 101. This language setting on the UE 101 may also affect the settings on the navigation application 109 to utilize the language setting on maps associated with the navigation application 109.

Then, at step 293, the navigation application 109 determines if the context values are valid. In one embodiment, context values are valid if the language setting on the UE 101 is compatible with the options on the navigation application 109 maps. For example, using a language setting for Russian may not be valid if the navigation application 109 does not support the Russian language. If the language settings are not valid, then another language setting is determined at step 291. If the context values are valid, the navigation application 109 determines if rules are needed and selects a rule to (step 295) to account for the language preferences. For example, a rule may be needed if there are two or more alternative languages available with requested maps associated with the navigation application 109. This may occur if the map of the area includes more than one language for names of places in the area. The rule may include a list of languages to present the names in an order of preference. If the metadata of the map includes the language that is preferred, that language will be used to present the names to the user. By way of example, the navigation application 109 determines if the rules are adequate to determine which set of names to use as described in FIGS. 2C and 2D. The rule may be adequate if the rule can be used to provide naming information as described in Table 1 for the user in the language associated with the context value.

The navigation application 109 then determines and provides guidance (step 297) based on the selected rule. As noted above, the guidance can include the city name in the language that is selected by identifying the context value. Thus, a user with a UE 101 associated with the Finnish language may receive information of the names of certain places on the map in the Finnish language when the user is in another country (e.g., Russia, Sweden, etc.) with names on the map stored in a different language by default. For example, in one embodiment, the metadata of the map includes street or other names in one or more languages depending on the country. The language of the name is selected based on the language setting on the UE 101. If the corresponding translation to the language setting exists in metadata, then a translation is shown. If not, then the name is shown in an available (e.g., default) language.

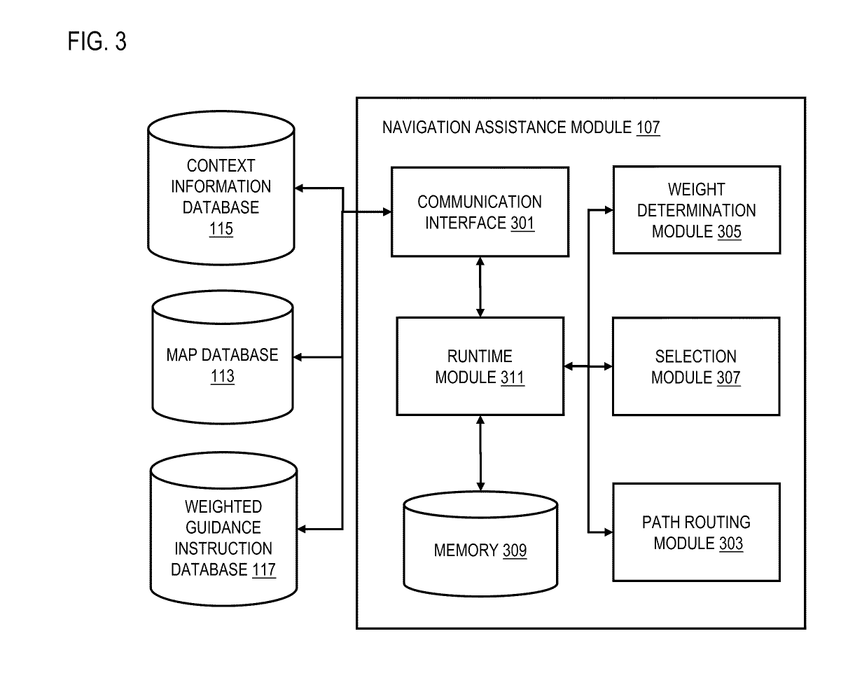

FIG. 3 is a diagram of the components of a navigation assistance module 107, according to one embodiment. By way of example, the navigation assistance module 107 includes one or more components for providing navigational assistance to a user based on the capability of the user to comprehend guidance information. It is contemplated that the functions of these components may be combined in one or more components or performed by other components of equivalent functionality. In this embodiment, the navigation assistance module 107 includes a communication interface 301, a path routing module 303 to determine paths associated with the navigational assistance, a weight determination module 305 to determine weights of paths and reference points associated with guidance instructions, a selection module 307, a memory 309, and a runtime module 311 to control execution of the navigation assistance module 107. The navigation assistance module 107 may be located on the navigation services platform 103 or the UE 101.

The communication interface 301 can be used to communicate with a UE 101, a navigation services platform 103, a context information database 115, a map database 113, a weighted guidance instruction database 117, a combination thereof, etc. Certain communications can be via methods such as an internet protocol, messaging, or any other communication method (e.g., via the communication network 105). Other communications may be via other data interfaces, such as a bus for fiber channel connections to a database. In some examples, the UE 101 can send a query to a navigation assistance module 107 on the navigation services platform 103 via the communication interface 301. The navigation assistance module 107 may then send a response back via the communication interface 301 (e.g., using a client server model as previously described).

The path routing module 303 can determine one or more routes from one or more places (e.g., a starting point) to one or more places (e.g., destinations). The path routing module 303 can receive start and end points for the path via the communication interface 301 and runtime module 311. Then, the path routing module 303 can retrieve a map of the area surrounding the start and end points from a map database 113. The path routing module 303 can then calculate a route based on various algorithms. In certain embodiments, more than one candidate path is determined based on attributes determined from the weighted guidance instruction database 117 for selection based on weights. The path routing module 303 may additionally be able to determine the path based on a type of travel of the user (e.g., pedestrian walking, biking, automobile, etc.). For example, this can be used to determine that certain paths or regions (e.g., a pedestrian cross walk, a region sectioned off by bollards, etc.) may become available when walking or biking, but may not be open while in an automobile. This information may be stored in the map database 113. Moreover, certain regions may be available to pedestrians, but not cycles, wheel chairs, or other wheeled vehicles (e.g., stairs on a pedestrian walkway). Moreover, the path routing module 303 may be able to route or reroute paths based on guidance instructions and/or reference points associated with guidance instructions. For example, if insufficient guidance instructions are available along a determined path to provide ample assistance to a user, the path routing module 303 may reroute the path to determine a new path with sufficient guidance instructions. This incident may occur if there is insufficient guidance information available at a guidance point (e.g., a point where the user needs to make a decision to turn, a busy intersection, etc.) to provide adequate guidance instructions.

In one embodiment, the weight determination module 305 is used to weight paths and reference points associated with guidance instructions, which may be later selected to present to the user using the selection module 307. The weights may be represented as numerical values. The weight determination module 305 can determine guidance instructions that are available at guidance points associated with paths determined by the path routing module 303. As noted above, guidance instructions may be associated with one or more landmarks, POIs, environmental conditions, or other reference points nearby the guidance points. At each of the guidance points, the weight determination module 305 may determine a set of guidance instructions based on the distance of the reference point(s) associated with the guidance instructions. The reference points may be retrieved from the map database 113 using the location of a guidance point as a reference.

The weight determination module 305 may then dynamically weight each of the reference points based on context information from the context information database 115 and/or information about the guidance instructions (e.g., based on reference points associated with the guidance instructions) from the map database 113 according to parameters associated with a user. In certain embodiments, the parameters are utilized to determine or augment rules used in the weighting process. In one example, a set of guidance instructions includes “turn left at Congress Avenue,” “turn left at Landmark,” and “turn left at Red Building.” The weighting can be based on each of a plurality of factors associated with the context information (e.g., based on the parameters). For example, if the user profile indicates that the user is illiterate, the “turn left at Congress Avenue” can be weighted negatively because it requires the user to be able to read the sign for Congress Avenue. Moreover, a weight may be attributed to the guidance instructions based on a salience of the reference point or landmark associated with the instructions. In this case, the Landmark may receive a greater weighting than the Red Building. For each guidance instruction or each landmark, grouping, or reference point weighting attributes can be set based on the contextual information. In other words, each reference point may have weightings associated with each possible variable of contextual information.

As previously noted, in certain embodiments, the parameters are associated with the weightings to augment weighting rules. One rule may weight reference points based on the salience, i.e., ability to distinguish and/or ability to recognize the reference point by the user. The rule may take into account parameters (e.g., comprehension parameters, weather parameters, etc.) that affect how much the user can recognize the reference point. For example, weather parameters may be utilized to affect how recognizable the reference point is based on weather. These parameters may be individualized to the reference points. For example, the weather parameter for cloudiness may affect how recognizable tall buildings, which may receive a negative weighting adjustment, are more so than street signs, which may receive a neutral weighting adjustment. In another example, comprehension parameters may be utilized to affect the rule based on a mapping of the user characteristics and characteristics of a reference point (e.g., color, language of text associated with the reference point, visibility at night, etc.).

Moreover, the weight determination module 305 may be utilized to determine weightings for paths. A weight for a path may be determined by determining each guidance point of the path and then determining a weight associated with each of the guidance points. The determined weight may be associated with a weight or a sum of weights of reference points associated with the guidance point or selected for the guidance point. Further, the weight for the path may be normalized based on the total number of guidance points in the path.

The selection module 307 may be utilized to select a path or a guidance instruction for presentation to the user. In certain embodiments, the selection module 307 selects a path with the greatest weight or greatest normalized weight compared to other paths. Further, the selection of the guidance instructions from a set of guidance instructions associated with a guidance point may be the guidance instruction with the greatest weight or a combination of two or more instructions. For example, “the red building with a grocery store on the first floor” may be more illustrative than “the red building.”

FIG. 4 is a flowchart of a process for providing navigational guidance instructions, according to one embodiment. In one embodiment, the runtime module 311 performs the process 400 and is implemented in, for instance, a chip set including a processor and a memory as shown FIG. 8. In step 401, the runtime module 311 receives a request from a UE 101 (e.g., a device) for guidance information to a destination. The guidance information may include route information to reach the destination and/or guidance instructions for following the route to the destination. Guidance instructions may include “take course of action” (e.g., turn left, turn right, etc.) based on a reference point (e.g., “the red barn,” “Main street,” “after five houses,” etc.). Further, the request may be received from a navigation application 109 on the UE 101. Under certain scenarios, the runtime module 311 executes on a navigation services platform 103 and in other scenarios the runtime module 311 executes on the UE 101. The request may specify a starting point and the destination. The starting point may be a location of the UE 101 and further can be periodically or continuously updated.

Then, the runtime module 311 determines contextual information related to an ability of a user of the UE 101 to comprehend the guidance information. As noted above, the contextual information may include information associated with a user profile, a trip profile, environmental data, safety data, or a combination thereof. Contextual information that includes an ability of the user to comprehend guidance information may further include impairment information (e.g., colorblindness information, cognitive impairment information, etc.) of the user or literacy information (e.g., whether the user is illiterate or functionally illiterate in a particular language) of the user.

At step 403, the runtime module 311 determines a plurality of candidate reference points associated with a route to the destination. Multiple candidate routes or paths to the destination may be determined based on various path routing algorithms. Then, the routes may be segmented into portions based on guidance points where guidance instructions should be provided to the user. At the guidance points, the runtime module 311 may search for nearby candidate reference points to base guidance instructions on. These candidate reference points may be associated with contextual characteristics such as the salience of the reference point, an indicator of a property of the reference point that makes the reference point salient (e.g., color, prominent letters, etc.), and/or contextual information (e.g., a bright neon sign might be more salient at night) that may change the saliency or the ability to be recognized of the reference point. The contextual characteristics may be retrieved from the context information database 115 and may be dynamic, that is, may change based on the circumstances (e.g., date, time, events, etc.).

Further, the runtime module 311 can retrieve one or more parameters such as, comprehension parameters associated with a user, safety parameters, comfort parameters, etc. The comprehension parameters can relate to the ability of the user to recognize guidance instructions based on characteristics of a reference point associated with the guidance instructions. The user may set requests for use of parameters (e.g., in a user profile) or the parameters may be determined by the runtime module 311. The parameters may be determined by the runtime module 311 based on questions asked to the user (e.g., questions that may be mapped to the parameters), based on a type of travel of the user (e.g., safety data associated with lighting of an alley may not be as relevant to a user in a car as a pedestrian user), etc. These parameters may be used as rules or be used to augment rules to select reference points. The rules may additionally be stored in the weighted guidance instruction database 117. As previously noted, according to certain embodiments, the rules can be based on the parameters (e.g., a comprehension parameter associating the user with colorblindness may signify a rule that reference points that are salient because of their respective color be eliminated from candidacy to be presented to the user).

Further, the comprehension parameters may include a literacy parameter, a visual impairment parameter, a language parameter, a combination thereof, etc. The literacy parameter may be associated with the ability of a user to recognize textual information on associated with a reference point. A user may not be able to comprehend instructions based on reading information associated with a reference point if the user illiterate or functionally illiterate (e.g., the user can read in one language, but the text is in another language). This may affect a saliency rating of the reference point for use by the user because the user cannot comprehend the textual information (e.g., a street sign). Moreover, the visual impairment parameter may be utilized to determine visual properties of the user that may make reference points more or less prominent to the user. For example, a visual impairment that the user is color blind may be utilized to determine whether the user can comprehend the saliency of a particular reference point. The particular reference point may be salient because of a prominent color of the reference point (e.g., the reference point is colored red and no other red structures are in the area). However, because the user is color blind (as indicated by the visual impairment parameter), the reference point is not salient to the user.

Moreover, in certain embodiments, the safety parameter is a factor of how safe an area associated with a reference point is. The safety parameter may include a lighting parameter, a crime parameter, a street accident parameter, or a combination thereof. The lighting parameter may include a visibility of the area during a night time and/or a day time. Further, a crime parameter may include criminal activity (e.g., thefts, robbery, mugging, murder, arson, etc.) associated with the area. Further, the street accident parameter might be utilized to determine hazardous street conditions to the user. The information in the safety parameter can be statistically correlated and/or normalized to create comparable information.

Further, in certain embodiments, comfort parameters may deal with a user's preference for physical or psychological comfort. As previously noted, comfort parameters may include characteristics of the user (e.g., whether the user is prone to motion sickness, whether the user has certain phobias or discomfort with certain POIs, etc.) and characteristics of a type of travel (e.g., it may be less comfortable to take a cobblestone path on a bike than in a car) of the user (e.g., set in a travel profile). Moreover, the phobias, prejudices, and discomfort, may be obtained from questions (either direct or indirect) that may be mapped to the comfort parameters. For example, a question may include “Are you a recovering alcoholic?” and if the response is yes, a mapping may set a psychological comfort indicator to not being comfortable around reference points nearby POIs associated with liquor.

Further, the candidate reference points associated with each of the guidance points may be weighted using the above described process associated with the weight determination module 305. Then, one or more candidate reference points may be selected based on the weightings (e.g., a reference point with the greatest weightings may be selected) (step 405). As previously noted, the selection may be based on the contextual characteristics, saliency, comprehension parameters, a combination thereof, etc. used in the weighting process.

Next, the runtime module 311 generates the guidance instructions based on the one or more selected reference points (step 407). As previously noted, guidance instructions may include “take course of action” (e.g., turn left, turn right, etc.) based on the selected reference point (e.g., “the blue tower,” “Washington Street,” “after five houses,” etc.). The course of action may be determined based on the route. Further, the guidance instructions may be in an audible format. The weighted guidance instruction database 117 may include information (e.g., a dictionary) for presenting the audible guidance instructions. Moreover, a language parameter may be utilized to output the guidance instructions in a language that the user can understand. Further, the reference points may be named according to different languages based on a language parameter (e.g., “First Street” in English may be named “Primera Calle” in Spanish).

FIG. 5 is a flowchart of a process for providing navigational guidance instructions, according to one embodiment. In one embodiment, the runtime module 311 performs the process 500 and is implemented in, for instance, a chip set including a processor and a memory as shown FIG. 8. The runtime module 311 may receive a request from a UE 101 for guidance information to a destination. At step 501, the runtime module 311 associates guidance points with one or more candidate paths (e.g., routes) from a starting location (e.g., the current location of the UE 101) to the destination. The reference points may be associated based on information retrieved from a weighted guidance instruction database 117, based on information from a map database 113, and/or context information database 115. Information from the map database 113 may be used to determine where guidance points along the path where guidance instructions based on the reference points may be provided to a user.

In step 503, the runtime module 311 determines user characteristics, topographical map data, and safety data associated with a path to the destination. User characteristics may be retrieved from a user profile specifying individual traits (e.g., the ability to comprehend guidance information, physical impairments, etc.) of the user. These user characteristics may be mapped onto parameters for weighting and/or selecting reference points to utilize in the path. Moreover, safety data (e.g., lighting for an area, crime data for the area, street accident data for the area, etc.) may be retrieved from the context information database 115. The safety data may further be associated with timing data. For example, an area may be considered safe during the day, but be considered unsafe at night.

Optionally, topographical map data may be retrieved from a map database 113. The topographical map data may be utilized to provide weightings for reference points and path routing. For example, route segments of a path may be weighted lower for the determination of a path if there is determined to be an uphill climb above a certain grade. Moreover, the topographical map data may indicate that portions of the map are inaccessible for routing a path the destination based on different travel modes that may be selected by the user.

Then, weightings for the guidance or reference points are determined based on the user characteristics, topographical data, and/or safety data (step 505). As previously noted, the reference points may have a base weight and weighting attributes (relationships between the reference point and parameters) stored in the weighted guidance instruction database 117. The runtime module 311 may cause, at least in part, the weighting of candidate reference points based on the parameters as detailed in the discussion of weight determination module 305. For example, user characteristics may be utilized to set parameters for what is important for weighting a candidate reference point (e.g., whether safety data or topographical data should be considered and if so, the extent of the weighting). Then, a weighting is determined for each of the reference points. Moreover, reference points are selected from the candidate reference points based on a comparison of weightings (e.g., the highest weighted candidate reference point may be selected). Weightings for reference points selected for each guidance point along the route may be utilized to determine the weighting for the respective reference points. Each of the routes may be associated with weightings based on the weightings of the set of reference points associated with the respective route as previously described. Once the paths are weighted, one of the paths may be selected based on the weighting. In certain embodiments, the guidance information may include the selected route and/or the guidance instructions associated with the selected route.

Once the candidate reference points are determined, one of paths may be selected based on the weighted guidance points (step 507). In certain embodiments, the highest rated guidance instruction is utilized to present (e.g., play an audible rendering of the instruction). The selected route is caused, at least in part, to be presented (step 509). In certain embodiments, the guidance instructions associated with the route as determined in FIG. 4 are presented. The guidance instructions may be presented in a graphical manner or aurally. For example, the guidance instructions may be provided to a text-to-speech mechanism that converts the guidance instructions into audible speech. Then, the audible speech is presented to the user.

In one example, the user requesting instructions to the destination may be associated with a characteristic that the user is in a wheel chair. As such, the user characteristics may indicate that because the user is in a wheel chair, routings available to the user should be weighted according to a comfort parameter based on the topographical map data for ease of movement of a user in a wheel chair. As such, certain grades of slopes of roadways may be weighted negatively when selecting a route for presentation to the user. Further, other regions (e.g., regions requiring the use of stairs) may be weighted negatively in determining a path to the destination.

In another example, the user may indicate that the user considers safety of a path an issue when traveling by foot. Under this scenario, the safety data may be utilized to determine weightings for reference points according to a safety parameter based on how safe an area is to travel in. For example, the path may be augmented to avoid a busy intersection that is prone to accidents, avoid dimly lit areas at night, or avoid high crime areas, according to the safety data by negatively weighting the busy intersection during the selection of the path. Then, selected guidance instructions may be presented to the user while navigating the path while avoiding the unsafe areas.

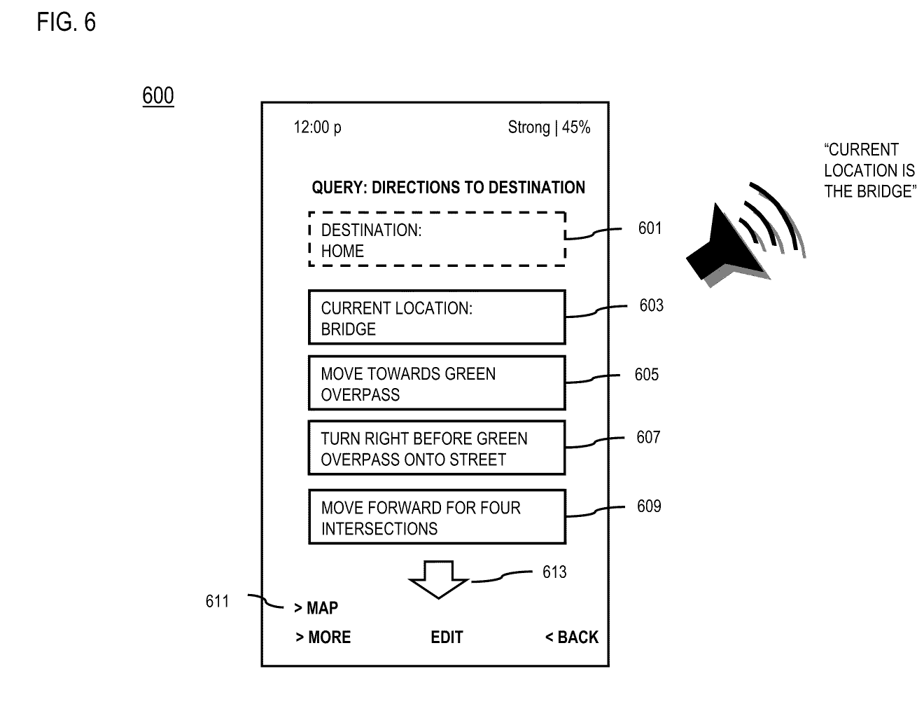

FIG. 6 is a diagram of a user interface utilized in the processes of FIGS. 4 and 5, according to one embodiment. The user interface 600 can include various methods of presentation. For example, the user interface 600 can have outputs including a visual component (e.g., a screen), an audio component that may be utilized to present audible guidance instructions, a physical component (e.g., vibrations), etc. User inputs can include a touch-screen interface, a scroll-and-click interface, a button interface, a microphone, etc. The user can be provided an area or a text box 601 to specify a destination. Alternatively or additionally, the user may specify a destination using audible commands. In one embodiment, the user selects a home point as the destination. The user interface 600 may also display the current location 603. Moreover, the current location may be audibly presented. The current location can include a description of a reference point that is associated with a guidance instruction associated with the current location 603. Moreover, the current location may be determined by the location module 111 of the UE 101. Further, as the user navigates along a path, more instructions 605, 607, 609 may be provided to the user. Additionally or alternative, the user may select a map button 611 to view a map display of the directions or select an additional instruction button 613 to view or listen to additional instructions.

With the above approach, users are advantageously provided guidance instructions for navigating to a destination in a manner that is tailored to the user. The guidance instructions may be customized based on the ability of the user to comprehend the instructions. In this manner, users that were previously unable to receive proper navigational instructions utilizing a UE 101 may now be provided useful navigational instructions. Moreover, the navigational instructions may be audible and thus allow the user to perform navigational actions without distraction. Moreover, the system 100 may leverage existing databases to efficiently create a weighted guidance instruction database 117 to determine guidance information.

The processes described herein for providing guidance information to a user may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

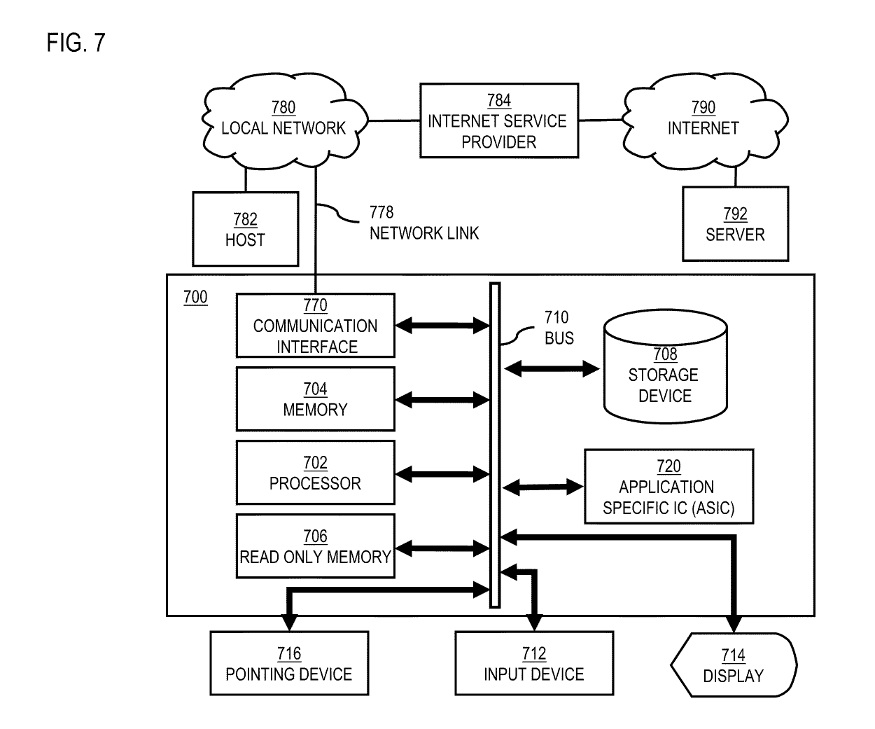

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to provide guidance information to a user as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of providing guidance information to a user.

A bus 710 includes one or more parallel conductors of information so that information is transferred quickly among devices coupled to the bus 710. One or more processors 702 for processing information are coupled with the bus 710.

A processor 702 performs a set of operations on information as specified by computer program code related to provide guidance information to a user. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or other dynamic storage device, stores information including processor instructions for providing guidance information to a user. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for providing guidance information to a user, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT) or a liquid crystal display (LCD), or plasma screen or printer for presenting text or images, and a pointing device 716, such as a mouse or a trackball or cursor direction keys, or motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for to the UE 101.

The term computer-readable medium is used herein to refer to any medium that participates in providing information to processor 702, including instructions for execution. Such a medium may take many forms, including, but not limited to, non-volatile media, volatile media and transmission media. Non-volatile media include, for example, optical or magnetic disks, such as storage device 708. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server hot 792 connected to the Internet hosts a process that provides a service in response to information received over the Internet. For example, server hot 792 hosts a process that provides information representing video data for presentation at display 714. It is contemplated that the components of system 700 can be deployed in various configurations within other computer systems, e.g., hot 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server hot 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as hot 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set 800 upon which an embodiment of the invention may be implemented. Chip set 800 is programmed to provide guidance information to a user as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 800, or a portion thereof, constitutes a means for performing one or more steps of providing guidance information to a user.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to provide guidance information to a user. The memory 805 also stores the data associated with or generated by the execution of the inventive steps.

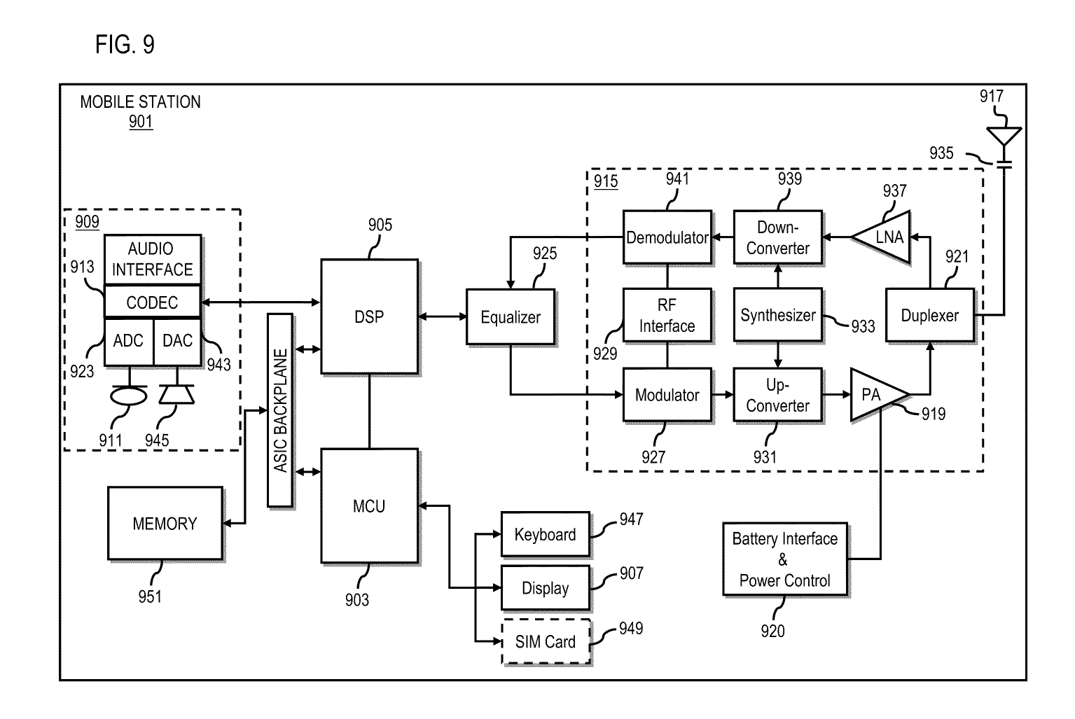

FIG. 9 is a diagram of exemplary components of a mobile terminal (e.g., handset) for communications, which is capable of operating in the system of FIG. 1, according to one embodiment. In some embodiments, mobile terminal 900, or a portion thereof, constitutes a means for performing one or more steps of providing guidance information to a user. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of providing guidance information to a user. The display 9 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903—which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to providing guidance information to a user. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving a request, from a device, for guidance information to a destination, wherein the guidance information includes, at least in part, instructions for following a route to the destination;
determining a plurality of candidate reference points associated with the route;
selecting one or more of the plurality of candidate reference points to include in the instructions based on saliency of the one or more candidate reference points with respect to one or more comprehension parameters associated with a user; and
generating the instructions based on the one or more selected reference points,
wherein the comprehension parameters relate to the ability of the user to recognize the selected one or more reference points.

2. A method of claim 1, further comprising:
retrieving contextual characteristics associated with the candidate reference points;
retrieving rules for weighting the candidate reference points; and
weighting the candidate reference points according to the retrieved rules based on the comprehension parameters and the contextual characteristics,
wherein the selection is based, at least in part, on the weighting.

3. A method of claim 2, wherein the comprehension parameters include a literacy parameter, a visual impairment parameter, or a combination thereof.

4. A method of claim 2, wherein the comprehension parameters include a language parameter, the method further comprising:
associating each of the selected reference points with a respective identifier corresponding to the language parameter,
wherein the instructions include the respective identifiers.

5. A method of claim 1, further comprising:
determining a plurality of candidate routes to the destination;
determining a set of selected reference points for each of the candidate routes;
retrieving rules for weighting the sets of selected reference points;
weighting the sets according to the retrieved rules based, at least in part, on the comprehension parameters; and
selecting the route based on the weighting,
wherein the guidance information includes the selected route.

6. A method of claim 5, further comprising:
retrieving safety data corresponding to each the candidate routes, the safety data including lighting data, crime data, street accident data, or a combination thereof; and
weighting the candidate routes based on the safety data,
wherein the selecting of the route is further based on the weighting of the safety data.

7. A method of claim 5, further comprising:
retrieving comfort data corresponding to each the candidate routes, the comfort data including topographical data, point of interest data, or a combination thereof; and
weighting the candidate routes based on the comfort data,
wherein the selecting of the route is further based on the weighting of the comfort data.

8. An apparatus comprising:
at least one processor; and
at least one memory including computer program code,
the at least one memory and the computer program code configured to, with the at least one processor, cause the apparatus to perform at least the following,
receive a request, from a device, for guidance information to a destination, wherein the guidance information includes, at least in part, instructions for following a route to the destination;
determine a plurality of candidate reference points associated with the route;
selecting one or more of the plurality of candidate reference points to include in the instructions based on saliency of the one or more candidate reference points with respect to one or more comprehension parameters associated with a user; and
generate the instructions based on the one or more selected reference points,
wherein the comprehension parameters relate to the ability of the user to recognize the selected one or more reference points.

9. An apparatus of claim 8, wherein the apparatus is further caused, at least in part, to:
retrieve contextual characteristics associated with the candidate reference points;
retrieve rules for weighting the candidate reference points; and
weight the candidate reference points according to the retrieved rules based on the comprehension parameters and the contextual characteristics,
wherein the selection is based, at least in part, on the weighting.

10. An apparatus of claim 9, wherein the comprehension parameters include a literacy parameter, a visual impairment parameter, or a combination thereof.

11. An apparatus of claim 9, wherein the comprehension parameters include a language parameter, and wherein the apparatus is further caused to:
associate each of the selected reference points with a respective identifier corresponding to the language parameter,
wherein the instructions include the respective identifiers.

12. An apparatus of claim 8, wherein the apparatus is further caused, at least in part, to:
determine a plurality of candidate routes to the destination;
determine a set of selected reference points for each of the candidate routes;
retrieve rules for weighting the sets of selected reference points;
weight the sets according to the retrieved rules based, at least in part, on the comprehension parameters; and
select the route based on the weighting,
wherein the guidance information includes the selected route.

13. An apparatus of claim 12, wherein the apparatus is further caused to:
retrieve safety data corresponding to each the candidate routes, the safety data including lighting data, crime data, street accident data, or a combination thereof; and
weight the candidate routes based on the safety data,
wherein the selecting of the route is further based on the weighting of the safety data.

14. An apparatus of claim 12, wherein the apparatus is further caused to:
retrieve comfort data corresponding to each the candidate routes, the comfort data including topographical data, point of interest data, or a combination thereof; and
weight the candidate routes based on the comfort data,
wherein the selecting of the route is further based on the weighting of the comfort data.

15. An apparatus of claim 8, wherein the apparatus is a mobile phone further comprising:
user interface circuitry and user interface software configured to facilitate user control of at least some functions of the mobile phone through use of a display and configured to respond to user input; and
a display and display circuitry configured to display at least a portion of a user interface of the mobile phone, the display and display circuitry configured to facilitate user control of at least some functions of the mobile phone.

16. A computer-readable storage medium carrying one or more sequences of one or more instructions which, when executed by one or more processors, cause an apparatus to at least perform the following steps:
receiving a request, from a device, for guidance information to a destination, wherein the guidance information includes, at least in part, instructions for following a route to the destination;
determining a plurality of candidate reference points associated with the route;
selecting one or more of the plurality of candidate reference points to include in the instructions based on saliency of the one or more candidate reference points with respect to one or more comprehension parameters associated with a user; and
generating the instructions based on the one or more selected reference points,
wherein the comprehension parameters relate to the ability of the user to recognize the selected one or more reference points.

17. A computer-readable storage medium of claim 16, wherein the apparatus is caused, at least in part, to further perform:
retrieving contextual characteristics associated with the candidate reference points;
retrieving rules for weighting the candidate reference points; and
weighting the candidate reference points according to the retrieved rules based on the comprehension parameters and the contextual characteristics,
wherein the selection is based, at least in part on the weighting.

18. A computer-readable storage medium of claim 17, wherein the comprehension parameters include a literacy parameter, a visual impairment parameter, or a combination thereof.

19. A computer-readable storage medium of claim 17, wherein the comprehension parameters include a language parameter, and wherein the apparatus is caused to further perform:
associating each of the selected reference points with a respective identifier corresponding to the language parameter,
wherein the instructions include the respective identifiers.

20. A computer-readable storage medium of claim 16, wherein the apparatus is caused to further perform:
determining a plurality of candidate routes to the destination;
determining a set of selected reference points for each of the candidate routes;
retrieving rules for weighting the sets of selected reference points;
weighting the sets according to the retrieved rules based, at least in part, on the comprehension parameters; and
selecting the route based on the weighting,
wherein the guidance information includes the selected route.
